(19) United States
(12) Patent Application Publication
(10) Pub. No.: US 2023/0265960 A1
(43) Pub. Date: Aug. 24, 2023

(54) PACKER FOR PIPE AND SEWER REHABILITATION

(71) Applicant: Dieter MEIER, Fürth (DE)

(72) Inventor: Dieter MEIER, Fürth (DE)

(21) Appl. No.: 18/110,560

(22) Filed: Feb. 16, 2023

(30) Foreign Application Priority Data
Feb. 24, 2022 (DE) 10 2022 104 411.4

(51) Int. Cl. F16L 55/134; F16L 55/165

(52) U.S. Cl. CPC F16L 55/134; F16L 55/1654; E03F 2003/065

(57) ABSTRACT

A packer for pipe and sewer rehabilitation, including a front and a rear flange, between which an expandable sleeve which can be filled with a pressure medium is arranged, wherein the rear and the front flange have lead-through openings which are connected by a hollow lead-through element within the sleeve, so as to be sealed in relation to the sleeve, and through which a feed line to a camera arrangement that is arranged adjoining the lead-through opening in the front flange and that includes a camera is guided, wherein the camera arrangement includes an extension element which is bendable in a radial direction and at the front end of which the camera is arranged, wherein the extension element is assigned an adjusting device for setting the radial bending thereof.

### CROSS-REFERENCE TO RELATED APPLICATIONS

The present application claims priority of DE 10 2022 104 411.4, filed Feb. 24, 2022, the priority of this application is hereby claimed, and the application is incorporated herein by reference.

### BACKGROUND OF THE INVENTION

The invention relates to a packer for pipe and sewer rehabilitation, comprising a front and a rear flange, between which an expandable sleeve which can be filled with a pressure medium is arranged.

Packers for rehabilitating pipelines and sewers are already known in the prior art and consist mostly of an expandable sleeve which is closed at both ends. A connection for air or water as pressure medium is usually provided on a rear side, wherein pulling eyes may be used, for example on both sides, for movement purposes. A laminate/liner is wrapped around the packer and the packer is introduced into the line to be rehabilitated. The laminate usually consists of a glass fiber fabric or a glass fiber mat, said fabric or mat having been impregnated with a synthetic resin. Once the packer, together with the laminate, has been introduced to the location to be rehabilitated in the sewer or the pipeline, it is filled with the pressure medium, wherein it expands and presses the laminate against the damaged location of the pipe wall. After the curing, the pressure medium is discharged and the packer is pulled out again, for example by means of the pulling eye. For positioning purposes, two-sided access is often utilized here.

In order to be able to also rehabilitate pipelines or sewer lines which have bends and/or which are accessible only from one side, DE 10 2006 034 652 A1 proposes a packer for pipe and sewer rehabilitation in which at least one flange has a through-opening which is connected to a hollow body that is arranged in the interior of the sleeve and sealed in relation thereto and that extends as far as the opposite flange, in which a blind hole or a through-opening having, at least in part, a smaller diameter may be present. During the insertion of the packer into the pipe to be rehabilitated or into the sewer to be rehabilitated, use may be made of a bar-like article which is slid through the through-opening in the first flange until it exerts a compressive force on the second, front flange during the insertion. In this way, the packer is also pulled during the insertion, and kinking is no longer possible. After the laminate has been introduced, a pulling eye can be used to pull out the packer again.

A problem with rehabilitation operations of this kind is, on the one hand, turning maneuvers in the case of branches, for which DE 10 2008 021 956 A1, for example, has proposed deforming the entire packer by means of an inner core. On the other hand, however, it is also difficult to position the packer at the correct location within the pipe system and/or sewer system to be rehabilitated. In this regard, a corresponding feed distance or pull distance is often implemented after a length measurement.

There is thus a need for an improved positionability of the packer and for the provision of a possibility of guiding the packer into a branch, for example from a ground line into an inflow.

### SUMMARY OF THE INVENTION

The object on which the invention is based is to specify a packer which is improved with regard to the monitoring of a rehabilitation operation and the positionability and which in particular allows a turning maneuver into branches.

To achieve this object, according to the invention, provision is made in the case of a packer of the type mentioned in the introduction for the rear and the front flange to have lead-through openings which are connected by a hollow lead-through element within the sleeve, so as to be sealed in relation to said sleeve, and through which a feed line to a camera arrangement that is arranged adjoining the lead-through opening in the front flange and that comprises a camera is guided. In this case, wherein the camera arrangement comprises an extension element which is bendable in a radial direction and at the front end of which the camera is arranged, wherein the extension element is assigned an adjusting device for setting the radial bending thereof.

It is thus proposed to attach a camera, which runs ahead of the front flange, to the packer, said camera making it possible to monitor the movement travel of the packer and to in particular also locate the correct location which is intended to be rehabilitated and to position the packer in an improved manner. The feed line to the camera arrangement, said feed line comprising the cable connections for the camera, is guided through the interior of the sleeve, in such a way as to not obstruct other use of the packer, wherein the lead-through element, which may be in the form in particular of a hollow body, provides protection. The feed line preferably comprises a “pipe eel”, in which cable connections can be guided. In this case, the lead-through element may, in particular, be a multi-purpose lead-through element.

Provision may for instance be made for the stiffness of the hollow lead-through element to be selected such that the spacing between the two flanges during movement and/or filling with the pressure medium remains at least substantially constant. The lead-through element extending between the two flanges thus prevents any kinking or any other undesired length reduction that could lead to sticking together of the laminate from occurring during the movement of the packer. In addition or as an alternative, the hollow lead-through element may be bendable in the radial direction, in order to simplify the operation of passing through bends and/or branches. By way of example, the lead-through element may be configured corresponding to the hollow body of DE 10 2006 034 652 A1 cited in the introduction.

Particularly in this context, but also generally, it is expedient for the lead-through openings and thus also the lead-through element to be arranged centrally with regard to the longitudinal direction of the packer. In terms of the stabilization and the adjustment capability that is still to be explained, a central arrangement is particularly advantageous. Furthermore, in such a configuration, the camera arrangement may also be arranged centrally on the front flange.

However, in the context of the present invention, configurations in which the lead-through element runs at least not completely centrally are also conceivable. By way of example, an expedient exemplary embodiment may provide for the lead-through opening in the front flange to be provided centrally in the flange, in particular with respect to the central attachment of the camera arrangement, whereas the lead-through opening in the rear flange is provided in a non-central manner, and the lead-through element connects the lead-through openings in a rectilinear manner. This may be expedient if it is preferred for the feed line to enter the packer at a point on the periphery, for example a central point at the rear end is desired as engagement point for rotation and sliding of the packer.

According to the invention, provision is made for the camera arrangement to comprise an extension element which is bendable in the radial direction and at the front end of which the camera is arranged, wherein the extension element is assigned an adjusting device for setting the radial bending thereof. Such an adjustment of the camera, which forms the front end of the packer, from the orientation in the longitudinal direction is useful not only to the extent that improved perception of the environment, that is to say of the interior of the pipe system and/or sewer system, with settable viewing angles is made possible, but it is also possible, with a sufficiently long configuration of the extension element, to achieve a movement aid, in particular in the region of branches in the pipe system and/or sewer system. It is for example conceivable to first look into a branch, for example an inflow from a ground line, by pivoting of the camera using the adjusting device, for example to determine whether it is the correct branch. Then, if it is possible to bend the camera arrangement far enough that it projects into the branch, the packer is automatically moved into this thus pre-selected branch. In this way, the camera arrangement serves a dual purpose, as an orientation and monitoring aid and as a navigation aid. Nevertheless, this configuration is useful not only with respect to the turning into branches, but there is also a significant simplification in the passing through pipe bends or generally line bends. The configuration of the camera arrangement and of the extension element may, in particular with regard to their dimensions, be selected such that the camera can detect the front flange and/or the sleeve of the packer and can thus monitor, for example, the introduction of the laminate. In particular, it is thus possible for the camera to be rotated up to 180°, with the result that it can look backward.

In a particularly advantageous configuration of the invention, provision may thus be made for the camera arrangement with the adjusting device to be configured as part of a guide device for guiding the packer into a branch, and/or for the adjusting device, in particular through selection of the length and/or radial bendability of the extension element, to be configured in such a way that the camera can be pivoted radially further than the radius of a line in which the packer is moved, in particular into the branch of the line.

Such camera arrangements with a bendable extension element are fundamentally already available for other applications and can also be used inexpensively and with little effort in the context of the present invention.

According to the invention, provision is made of a single packer main arrangement, which is formed by the front flange, the rear flange and the sleeve. In other words, the packer comprises exactly one front flange, exactly one rear flange and exactly one sleeve.

While it is in principle conceivable for an adjustment motor or some other controllable adjustment actuator which can be operated and controlled from outside the pipe system and/or sewer system by means of the feed line and further-guided cable connections to be used in the adjusting device, preference is given to using an easily implementable, mechanical or manual adjustment means.

A particularly advantageous configuration of the invention thus provides for the feed line to be mounted in the lead-through element in a displaceable manner and for the adjusting device to comprise a fastening means which connects a first fastening point that is spaced apart from the front flange and that is in particular arranged at the front end of the extension element to a second fastening point radially spaced apart from the lead-through opening in the front flange. In particular, the configuration is therefore of the kind that, in the event of a displacement of the feed line and thus of the camera arrangement against the front flange, a radial adjustment of the extension element and thus of the camera is effected on account of the non-elastic, but flexible fastening means. The camera arrangement adjoining the end of the feed line is thus not fastened directly to the front flange, but rather coupled thereto at a more remote point by means of the fastening means. In the basic state, the extension element is oriented entirely in the longitudinal direction and is coupled obliquely with respect thereto to the front flange by way of the fastening means. If the feed line and thus the camera arrangement is then slid forward, since the fastening means is not length-variable, the extension element is bent in the direction of the second fastening point. Expediently, in the basic state, it is possible here for the camera arrangement to bear against the front flange and/or for at least that part of the feed line which can slide through the lead-through opening in the front flange to be of stiff configuration. Retraction of the feed line and thus of the camera arrangement also returns the orientation steadily into the longitudinal direction. Expediently, there is, in particular running after the lead-through opening in the rear flange, also an arresting apparatus which defines a maximum advancement distance. In this case, it may be, for example, a clamp or the like which is placed around the continuation of the feed line outside the sleeve. However, other configurations for delimiting the permissible advancement distance, in particular feed distance, are also conceivable. The fastening means may be, in particular, a wire and/or a chain, which may be fastened to the first and the second fastening point for example by means of eyes or other fixing means. In an advantageous alternative and/or as an addition to a wire and/or a chain, the fastening means may also be a tear-resistant thread, for example a Perlon thread.

It should already be noted at this point that bending of the extension element in a predefined direction with respect to the packer, as occurs in the event of coupling by means of the fastening means, still enables a glimpse in all conceivable radial directions. This is because a rotation of the packer overall makes it possible to see in all directions by way of the camera. Corresponding operating possibilities, ideally combined with a feed and/or retraction of the packer overall, will be explained in more detail below.

The extension element may preferably comprise a tightly wound spring with windings that adjoin one another, in particular composed of a metal such as stainless high-grade steel. Where appropriate, there may be a restoring force into the basic state in the longitudinal direction, which may be particularly advantageous in the event of a manual-mechanical actuation by sliding. However, other configurations which, while having sufficient flexural stiffness to maintain a bending position, still permit adjustment by means of the adjusting device are also conceivable. By way of example, the extension element may comprise a silicone hose.

In this context, it is also advantageous for the camera arrangement to comprise a camera head which comprises the camera and the edges of which are of at least substantially round configuration, in order to further promote guidance around corners/into branches. By way of example, it is possible for a substantially spherical configuration to be selected.

The feed line may preferably be extended as far as a distal operating portion, which has to be arranged at least partially outside the pipe or sewer. Particularly in the case of manual-mechanical movement by displacement of the feed line and thus also of the camera arrangement, simple handling from outside the pipe system and/or sewer system is then provided, in particular together with a second operating possibility for rotation of the packer and/or feed/retraction of the packer. The extension may be effected, for example, on the basis of a sliding linkage or the like.

The packer preferably also comprises a coupling means on the rear flange, said coupling means being able to be used for the coupling of a linkage or the like in order to enable a rotation of the packer and/or a feed and/or retraction of the packer. Corresponding couplable operating means and linkages are already known from the prior art. The operating means is then located at least partially outside the pipe system and/or sewer system, in particular adjacent to the operating portion, which is configured in particular for displacement purposes, of the extension of the feed line. By means of the operating portion, the orientation of the camera with respect to the longitudinal direction can be set by sliding of the camera arrangement, in order to then set the direction for example by rotation by means of the operating means. It is also possible for feeding and retraction in the pipe system and/or sewer system to be effected by way of the operating means likewise in a mechanical manner and with little effort.

Preferably, a pressure medium connection for the pressure medium may be provided on the rear flange, said pressure medium connection comprising the coupling means for coupling of the operating means which is to be used at least to rotate the packer. In this case, an operating means may be used which also permits the feed line and the discharge of the pressure medium, in order to combine a plurality of functions. The coupling is then effected in such a way that the packer is rotationally coupled to the operating means. The coupling means may then be, for example, a rotary linkage connection, possibly a rotary linkage and push-rod linkage connection.

Briefly summarized, preferred exemplary embodiments of the packer according to the invention thus provide for a camera arrangement to be attached at the front end of the packer. A “pipe eel”, or similar, as feed line may be used to supply said camera arrangement with power and to slide it forward and backward. In order to enable turning of the camera, a flexible connection (wire, cord, chain, thread (in particular Perlon thread), or similar, as fastening means) is preferably established from the camera head to the packer head (front flange). In order to control the camera arrangement, the feed line, in particular the “pipe eel”, is moved forward or backward. The scope of this freedom of movement may be delimited by means of an arresting means at the front end and the plug-in connection or arresting means at the rear end of the “pipe eel”. In order to perform a turning maneuver into a branch, in particular an inflow, the camera arrangement and/or the packer may be steered to the left or right. This may also be effected by the rotation of the packer by means of push rods or similar. The passing through pipe bends is improved considerably by the steerability of the camera arrangement. In order for the packer to be able to be turned in all directions, the packer may be rotated with respect to the air supply by means of the push rods.

The feed line may comprise a fiberglass rod within the lead-through element, said fiberglass rod comprising cable connections to the camera and in particular delimiting the longitudinal expansion of the packer. Such fiberglass rods with integrated cable connections are already known and extremely robust, and thus particularly suitable for use in the packer. They may be used to delimit the longitudinal expansion of the packer. By way of example, the fiberglass rod may be connected to a supply line of the feed line by plug-in connections, said supply line adjoining the rear flange and/or the front flange. Particularly if further cable connections, for example to LEDs of a curing device, are to be provided, a 6 pole connector is preferred.

Provision may particularly advantageously be provided for at least one UV light source of a curing device to be arranged within the transparent sleeve, in particular on the lead-through element, said at least one UV light source being able to be operated via cable connections within the feed line. If the sleeve of the packer is transparent, light sources, in particular UV LEDs, which enable rapid curing by UV rays, may be fitted within the packer.

It is particularly preferred for the sleeve of the packer, which may also be referred to as inflation hose, to consist of a fabric-free material. As an alternative, the sleeve may also be entirely or partially reinforced with fabric, depending on the material and embodiment.

Provision may also be made for the packer to comprise a through-opening for liquids of the pipe system and/or sewer system, in particular waste water, said through-opening extending in the interior of the packer between the two flanges. During the rehabilitation operation, the liquid can then flow away through this through-opening, and complex shutting off and pumping away, and possibly re-routing, of the liquid is not required.

In the case of the packer according to the invention, provision may also be made for at least one flange to have, on its inner side, a conical portion which is directed toward the inner side of the packer and to the outer side of which a holding ring is attached or can be attached. Both flanges preferably have such a conical portion. The holding ring or rings press the sleeve of the packer against the conical portion, such that a particularly good sealing is produced when the sleeve is filled with the pressure medium. The greater the internal pressure in the sleeve, the stronger the pressing of the sleeve against the conical portion too.

A pipe and/or sewer rehabilitation arrangement comprising the packer according to the invention may, for example, also comprise an output device for images of the camera, in particular a display and/or a monitor, said output device in particular being arranged on an operating arrangement with the operating means and/or the operating portion. By means of the extended feed line, which contains the cable connections to the camera, image data of the camera can be transmitted to the outside and displayed on the output device. In a method for moving a packer according to the invention in a pipe system and/or sewer system, the movement travel, in particular also the reaching of the movement destination, of the packer is monitored by means of the camera. The movement travel may, particularly if an adjusting device is provided, be predefined by the adjusting device by adjustment of the camera arrangement.

Further advantages and particulars of the present invention arise out of the exemplary embodiment described in the following and also from the associated drawings.

### BRIEF DESCRIPTION OF THE DRAWING

In the drawing:

FIG. 1 shows a first exemplary embodiment of a packer according to the invention in a basic state,

FIG. 2 shows the first exemplary embodiment in a state in which the orientation of the camera has changed,

FIG. 3 shows a second exemplary embodiment of a packer according to the invention, and

FIG. 4 shows a schematic diagram of a pipe and/or sewer rehabilitation arrangement.

### DETAILED DESCRIPTION OF THE INVENTION

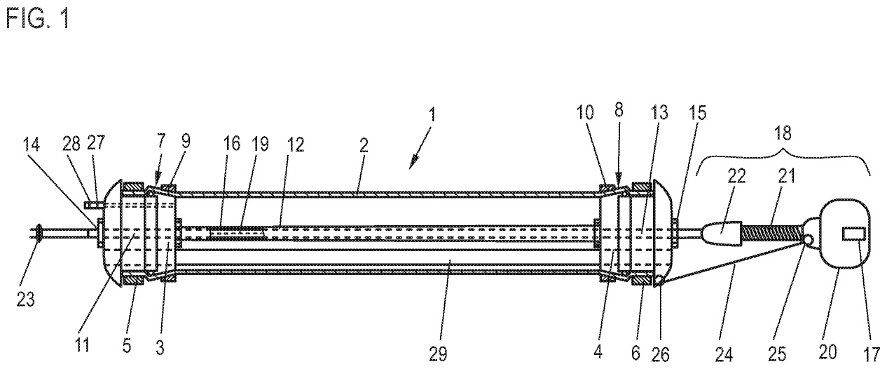

FIG. 1 shows a packer 1 according to the invention. The packer 1 comprises exactly one sleeve 2 in the form of an inflation hose which serves as outer shell and which is of hose-like configuration and consists of an expandable fabric-free or at least partially fabric-reinforced material. Exactly one flange 3, 4 is arranged at each of the two end portions of the sleeve 2, the sleeve 2 being firmly connected to the flanges 3, 4 by means of clamping rings 5, 6. The flanges 3, 4 each comprise an encircling groove (not shown in any more detail), in order to avoid slipping of the sleeve 2, and also, on their inner side, a conical portion 7, 8 against which the sleeve 2 bears. On the outer side, a respective clamp 9, 10 is attached at this location.

The rear flange 3 illustrated on the left in FIG. 1 comprises an axial lead-through opening 11 which transitions into a cylindrical, hollow lead-through element 12 in the interior of the packer 1. The other end of the lead-through element 12 is adjoined by a through-opening 13 in the front flange 4, said through-opening in the present case having the same diameter as the through-opening 11 in the rear flange 3. A respective collar 14, 15 may be present on the outer sides of the flanges 3, 4.

The leadthrough formed by the lead-through openings 11, 13 and the lead-through element 12 is used to guide a feed line 16 to a camera 17 of a camera arrangement 18 in a displaceable manner. This feed line 16 contains, in particular, the cable connections 19 to the camera 17, for example two wires for supplying power and a wire for transmitting image data and/or controlling the camera 17. Furthermore, said feed line may also contain cable connections to UV LEDs (not illustrated) of a curing device which are arranged within the, in this case, transparent sleeve 2.

The camera arrangement 18 comprises a camera head 20 with greatly rounded edges which contains the camera 17 in a central and preferably set-back manner, said camera being oriented toward the front along the longitudinal direction in the basic state shown in FIG. 1. In addition, an illuminant which can be operated via the feed line may also be present, in order to illuminate the field of view of the camera 17. The camera head 20, which may consist, for example, of plastic or metal, is connected to the feed line 16 by way of an extension element 21, here a tightly wound metal spring, the windings of which bear against one another, and a connecting element 22. The extension element 21 is of bendable design. Even though in FIG. 1 the basic state with camera 17 directed straight ahead is shown in such a way that a part of the feed line 16 projects out of the lead-through opening 13, preferred configurations in which the connecting element 22, the diameter of which is greater than that of the lead-through opening 13, bears directly against the lead-through opening 13 are nevertheless also possible. In both cases, a delimitation for a sliding distance of the feed line 16 is formed, which can be extended from the rear end as far as an operating portion outside the pipe system and/or sewer system. Along this extension which is also indicated in FIG. 1, a further delimitation may be provided by means of a clamp 23 or the like.

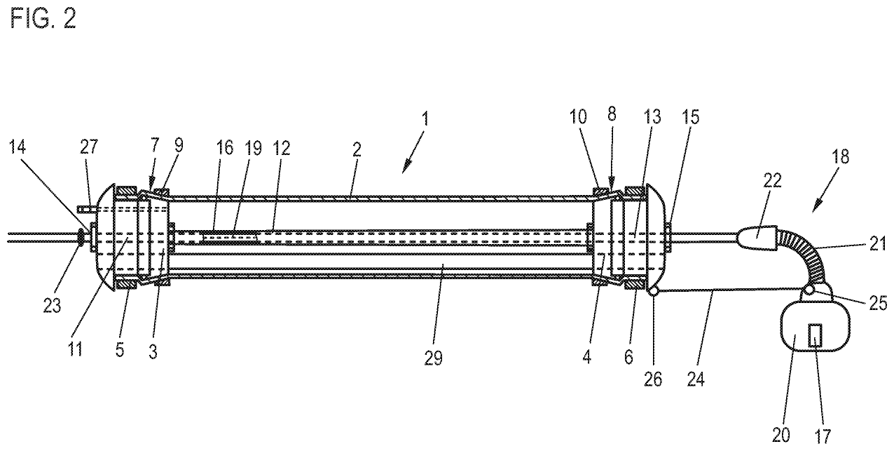

By means of a fastening means 24, here a wire and/or a chain and/or a thread, in particular Perlon thread, the camera arrangement 18 is coupled to the front flange 4, specifically between a first fastening point 25 at or adjacent to the front end of the extension element 21, in particular at the camera head 20, and a second fastening point 26 on the radially outer periphery of the rear side of the front flange 4. On account of this coupling, when the feed line 16 is slid out, as shown in FIG. 2, the extension element 21 bends toward the side of the second fastening point 26, with the result that the orientation of the camera 17 changes, specifically the camera 17 is pivoted to the side.

Since the length of the camera arrangement 18 is 20 cm in this exemplary embodiment, the camera head 20 can also be pivoted into lines that branch off and, when held in such a position, guides the entire packer 1 therein. This is simplified by the rounded edges of the camera head 20.

Furthermore, the packer 1 also comprises a pressure medium connection 27 in order to supply pressure medium into the sleeve. In the present case, the pressure medium connection is also provided with a coupling means 28, here a rotary linkage and push-rod linkage connection, in order to connect a rotary linkage and push-rod linkage, which also leads to outside the pipe and sewer system to form an operating means in order to rotate and to slide/retract the packer 1. Rotation of the packer 1 makes it possible to set different viewing directions of the camera 17.

In this way, the movement travel of the packer 1 in the pipe and sewer system can thus be monitored and the location to be rehabilitated can be reliably located. In addition, the adjustable camera arrangement 18 also makes navigation easier, as described, both with regard to branches and with regard to bends to be passed through. In particular, the lead-through element 12 may also be designed such that it can be bent radially in the interior of the sleeve 2, but maintains the spacing between the flanges 3, 4 on account of its stiffness. It is thus also possible for bends to be passed through in a simple manner, in particular without kinking.

After the location to be rehabilitated has been reached, the interior of the sleeve 2 is filled with a pressure medium such as air or water via a pressure medium connection 27, as a result of which a laminate, which is wound onto the sleeve 2 and which is not illustrated in the figures, is pressed against the pipe wall and/or sewer wall. The laminate is impregnated with a synthetic resin or a similar material which cures due to a supply of heat, in particular by means of the UV LEDs, or after a predefined time. After the curing operation has ended, the pressure medium is discharged and the packer 1 is pulled back again by means of the linkage coupled to the pressure medium connection 27. Lines and sewers which are accessible only from one side can also be rehabilitated using the packer 1.

In order to make it possible for any waste water or other liquids to flow away during the rehabilitation operation, the packer 1 comprises an axial through-opening 29 for waste water which—like the leadthrough also—is sealed in relation to the interior of the sleeve 2.

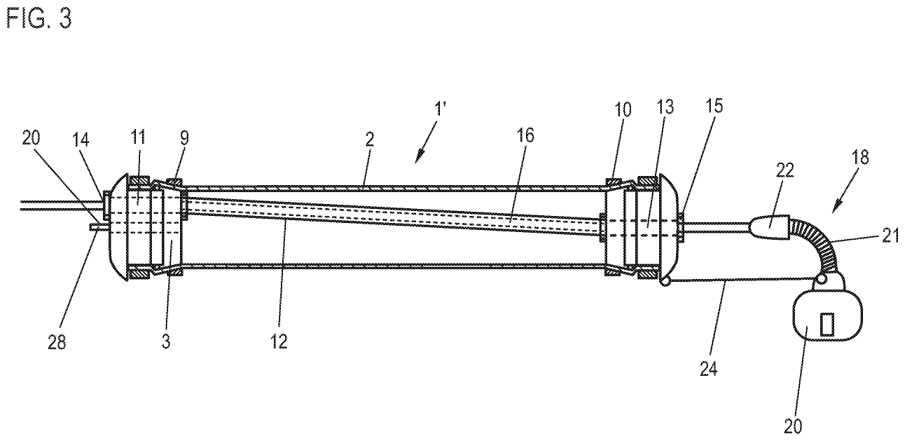

FIG. 3 shows an exemplary embodiment of a packer 1′ which is modified slightly in relation to FIG. 1 and FIG. 2, in which, for the sake of simplicity, corresponding components are denoted by the same reference signs. In contrast to the packer 1, in which the lead-through openings 11 and 13 are provided centrally, the lead-through opening 11 is provided radially outwardly here and the pressure medium connection 27 centrally, in order to permit easier rotation and sliding/pulling by means of the operating means. The lead-through element 12 thus runs at an angle with respect to the longitudinal direction, but still allows the feed line 16 to be displaced.

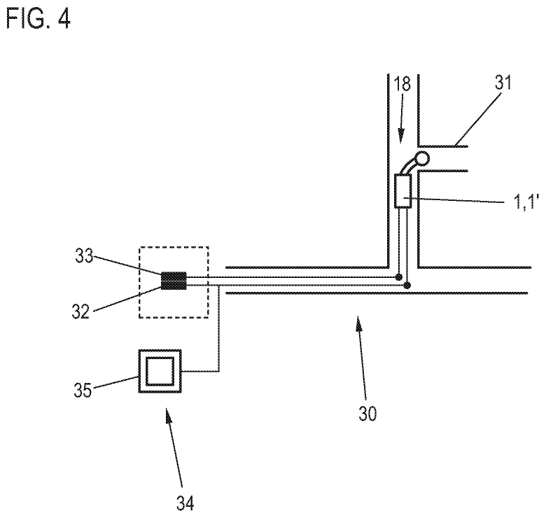

FIG. 4 schematically shows the packer 1, 1′ in a pipe system and/or sewer system 30 at a branch 31. The operating portion 32 for the camera arrangement 18 has been slid forward, such that said camera arrangement projects into the branch 31. By means of the operating means 33, the packer 1, 1′ can then also be slid into the branch 31. Also shown is an output device 34, here a display 35, for images of the camera 17, which output device may be arranged, for example, on the operating arrangement with the operating portion 32 and the operating means 33.

In all the exemplary embodiments, the feed line 16 may comprise a “pipe eel”, in which the cable connections are guided. As an alternative or in addition, it is conceivable to use a fiberglass rod within the lead-through element 12, said fiberglass rod containing the cable connections. Said fiberglass rod may be connected, in particular on both sides, to further-conducting supply lines by way of corresponding plug-in connections, for example 6 pole plug-in connections if the cable connections 19 for the camera 17 and for the UV LEDs are contained.

While specific embodiments of the invention have been shown and described in detail to illustrate the inventive principles, it will be understood that the invention may be embodied otherwise without departing from such principles.

We claim:

1. A packer for pipe and sewer rehabilitation, comprising a front and a rear flange, between which an expandable sleeve which can be filled with a pressure medium is arranged, wherein the rear and the front flange have lead-through openings which are connected by a hollow lead-through element within the sleeve, so as to be sealed in relation to said sleeve, and through which a feed line to a camera arrangement that is arranged adjoining the lead-through opening in the front flange and that comprises a camera is guided, wherein the camera arrangement comprises an extension element which is bendable in a radial direction and at the front end of which the camera is arranged, wherein the extension element is assigned an adjusting device for setting the radial bending thereof.

2. The packer according to claim 1, wherein the camera arrangement with the adjusting device is configured as part of a guide device for guiding the packer into a branch, and/or the adjusting device, in particular through selection of the length and/or radial bendability of the extension element, is configured in such a way that the camera can be pivoted radially further than the radius of a line in which the packer is moved, in particular into the branch of the line.

3. The packer according to claim 1, wherein the feed line is mounted in the lead-through element in a displaceable manner and the adjusting device comprises a fastening means which connects a first fastening point that is spaced apart from the front flange and that is in particular arranged at the front end of the extension element to a second fastening point radially spaced apart from the lead-through opening in the front flange.

4. The packer according to claim 3, wherein the fastening means is a wire and/or a chain and/or a tear-resistant thread.

5. The packer according to claim 1, wherein the feed line is extended as far as a distal operating portion, which has to be arranged at least partially outside the pipe or sewer.

6. The packer according to claim 1, wherein a pressure medium connection for the pressure medium is provided on the rear flange, said pressure medium connection comprising a coupling means for coupling of an operating means which is to be used at least to rotate the packer.

7. The packer according to claim 1, wherein the feed line comprises a fiberglass rod within the lead-through element, said fiberglass rod comprising cable connections to the camera and in particular delimiting the longitudinal expansion of the packer.

8. The packer according to claim 7, wherein the fiberglass rod is connected to a supply line of the feed line by plug-in connections, said supply line adjoining the rear flange and/or the front flange.

9. The packer according to claim 1, wherein at least one UV light source of a curing device is arranged within the transparent sleeve, in particular on the lead-through element, said at least one UV light source being able to be operated via cable connections within the feed line.

10. The packer according to claim 1, wherein the stiffness of the hollow lead-through element is selected such that the spacing between the two flanges during movement and/or filling with the pressure medium remains at least substantially constant.
